(19) United States
(12) Patent Application Publication
(10) Pub. No.: US 2019/0032873 A1
(43) Pub. Date: Jan. 31, 2019

(54) TROFFER RETROFITTING

(71) Applicant: PHILIPS LIGHTING HOLDING B.V., EINDHOVEN (NL)

(72) Inventors: WALTHERUS EMERICUS JOHANNES VAN GOMPEL, EERSEL (NL); MARK EDUARD JOHAN SPIKES, WAALRE (NL)

(21) Appl. No.: 16/077,443

(22) PCT Filed: Feb. 14, 2017
(86) PCT No.: PCT/EP2017/053229

§ 371 Date: Aug. 10, 2018

(30) Foreign Application Priority Data
Feb. 25, 2016 (EP) 16157261.5

(51) Int. Cl. F21S 8/02; F21V 19/00

(52) U.S. Cl. CPC F21S 8/026; F21Y 2115/10; F21V 19/005; F21V 19/0055

(57) ABSTRACT

A mounting bracket arrangement is disclosed for retrofitting an LED panel (20) in between opposing end surfaces of a troffer (60). The mounting bracket arrangement comprises a pair of mounting brackets (10), each mounting bracket comprising a major edge (111) for abutting the mounting bracket against one of said end surfaces; an alignment edge (103) extending transversely from the major edge; an affixing portion (130) having a contact surface for contacting a roof section (65) of the troffer; and a mounting hook (140) extending from the affixing portion for hanging the LED panel from the mounting bracket. A LED panel retrofit kit and method of fitting such a retrofit kit in a troffer using such a mounting bracket arrangement are also disclosed.

### FIELD OF THE INVENTION

The present invention relates to a mounting bracket arrangement for retrofitting an LED panel into a troffer.

The present invention further relates to an LED panel retrofit kit comprising such a mounting bracket arrangement.

The present invention further relates to a method of retrofitting an LED panel into a troffer using such an LED panel retrofit kit.

### BACKGROUND OF THE INVENTION

LED lighting is rapidly growing in popularity due to its low energy cost and superior lifetimes compared to traditional lighting such as incandescent or fluorescent lighting. In addition, because the cost of LED lighting is coming down, the initial investment to install LED lighting has become more affordable, which has aided the popularity of LED lighting.

Retrofitting LED lighting into existing luminaries can be straightforward if it simply requires the replacement of the traditional light source with an LED equivalent, e.g. the replacement of a halogen or incandescent light bulb with its LED version. However, for certain luminaries such a retrofit is more cumbersome, for example luminaries housing fluorescent tubes such as troffers as in such luminaries the fluorescent tubes are typically replaced by strips of LED lighting, e.g. LED boards or panels, which means that the fittings of the fluorescent tubes typically cannot be reused. Instead, the LED boards may have to be individually mounted in the troffer, e.g. by screwing, or mounting brackets are screwed to the troffer in which the LED panel is mounted.

Incorrect alignment of such fixings can cause the troffer to exhibit poor illumination characteristics in terms of homogeneity due to misalignment of the LEDs within the troffer, e.g. giving the troffer a chaotic appearance when the LEDs are switched on, for example compared to other troffers in a ceiling comprising multiple troffers. Moreover, electrical connection of such LED boards or panels is cumbersome because the ballast or driver of the LEDs may not be accessible once the LED boards or panels are affixed to the troffer, such that such electrical connections must be established beforehand whilst the LED board or panel is unsecured.

U.S. Pat. No. 8,523,383 B1 discloses a retrofit kit assembly for a recessed lighting fixture. The retrofit kit includes at least two mounting brackets, which can each include at least one lamp socket for a linear LED lamp. The kit also includes at least one ballast, which may be pre-wired to the sockets. Each ballast may include a temporary adhesive on a mounting side thereof, for use during the installation process. For example, the installer may provisionally mount the ballast to an interior surface of an existing housing of the fixture and then permanently mount the ballast using one or more fasteners. The mounting brackets and ballast of the kit may include captive hardware which is held in place in the aperture for the fastener prior to fastening the particular object to the recessed housing, which reduces risk of dropping or losing fasteners during installation. However, this solution requires the use of separate LED lamps instead of an LED panel having multiple LED arrays on a major surface, which often is not cost-effective or desirable. Moreover, this assembly does not facilitate easy electrical connection after the LED lamps have been fitted to the brackets.

### SUMMARY OF THE INVENTION

The present invention seeks to provide a mounting bracket arrangement that can be easily aligned in the troffer and that facilitates electrical connection of an LED panel to a power supply once the LED panel is attached to the mounting bracket arrangement.

The present invention further seeks to provide an LED panel retrofit kit for a troffer including such a mounting bracket arrangement.

The present invention yet further seeks to provide a method of retrofitting such an LED panel retrofit kit into a troffer.

According to an aspect, there is provided a mounting bracket arrangement for retrofitting an LED panel in between opposing end surfaces of a troffer, the mounting bracket arrangement comprising a pair of mounting brackets, each mounting bracket comprising a major edge for abutting the mounting bracket against one of said end surfaces; an alignment edge extending transversely from the major edge; an affixing portion having a contact surface for contacting a roof section of the troffer; and a mounting hook-extending from the affixing portion for hanging the LED panel from the mounting bracket, said mounting hook having an elongated slot or groove with an opening, and said slot or groove extends in a direction alongside the alignment edge. The alignment edge extends in a first direction, i.e. x-direction transverse to the direction of the major edge which extends in a second direction, i.e. y-direction, a third direction, i.e. z-direction, is normal to both the first and second direction. Hence, the slot or groove extends alongside the alignment edge means that it extends (approximately) in the x-direction. Such a bracket arrangement may be accurately fitted into the troffer by virtue of the alignment features of the respective mounting brackets whilst electric connection of the LED panel is facilitated by the LED panel hanging from the mounting hooks when fitted to the mounting brackets. Because each of the mounting brackets, which abuts with its major edge against the end surfaces of the troffer together with the mounting hook extending transverse to said major edge and the orientation of the groove/slot, the distance between the pair of mounting brackets, used for mounting the LED panel, is automatically adapted to the size of the troffer while the mounting hooks enable a grip of the LED panel anywhere along the length direction of the LED panel (see for example FIG. 5). Thus mounting of the LED panel in the troffer is simplified. Further, the mounting hooks facilitate hinging or swiveling the LED panel into its final position once the electrical connections have been established.

To this end, each mounting hook may have a first section extending from the affixing portion, a second section extending from an edge of the first section parallel to the contact surface of the affixing portion and a third section extending from an edge of the second section towards said contact surface, the first, second and third section enclosing the elongated slot or groove with the opening of the slot or groove facing the contact surface, i.e. for facing towards the roof section. This hook geometry facilitates supporting the LED panel on the second section when the LED panel is hanging from the mounting brackets. For example, each mounting hook may have a U-shape.

Typically, the respective mounting brackets will be mirror images of each other although this is not essential.

In an embodiment, each mounting bracket has a stepped profile comprising a first step portion including the major edge, the affixing portion as a second step portion and an adjoining portion extending from the first step portion to the second step portion. Such a geometry facilitates the mounting of the mounting brackets to the troffer.

Each mounting bracket may further comprise a first edge shared by the first step portion, the adjoining surface portion and the second step portion; wherein the second step portion comprises a first further edge opposing the first edge, the mounting hook-extending from the first further edge in the direction of the first step portion. The clearance between the first edge and the mounting hook facilitates affixing the mounting bracket to the roof section of the troffer, e.g. by providing easy access to at least one aperture for allowing a screw thread to pass through the aperture in the affixing portion.

Each mounting bracket may further comprise an alignment portion extending from the adjoining portion, wherein the alignment edge is shared by the first surface portion, the adjoining portion and the alignment portion; wherein the alignment portion comprises a second further edge opposing the alignment edge, the first further edge and the second further edge facing each other and being spatially separated, optionally wherein the alignment portion further comprises a visual marker for aligning the alignment edge with a reference location in the troffer, e.g. a (virtual) centre line of the troffer. Such an alignment portion aids the correct positioning of each mounting bracket within the troffer.

The major edge of each mounting bracket may comprise a pair of protrusions near opposite ends of the major edge for positioning the major edge against the end surface of the troffer. This facilitates the correct positioning of the major edge against such an end surface in case the end surface is not flat or flush, in which case it may not be feasible for the entire major edge to abut the end surface of the troffer.

Each mounting bracket may comprise an adhesive area for adhering the mounting bracket to the roof section of the troffer for at least temporarily adhering the mounting bracket to the roof section of the troffer, the adhesive area being arranged on a contact surface of the mounting bracket for contacting the roof section of the troffer. Such an adhesive area assists in keeping the mounting bracket in its correct position whilst securing, e.g. screwing, the mounting bracket onto the roof section of the troffer, thereby facilitating a particularly user-friendly installation of the brackets in a troffer.

According to another aspect, there is provided an LED panel retrofit kit for a troffer, the kit comprising the mounting bracket arrangement of any of the embodiments described in this application and an LED panel comprising an edge profile for engaging with the respective hook members of the mounting brackets. Such an LED panel retrofit kit facilitates retrofitting a troffer with an LED panel in a more straightforward and accurate manner.

The LED panel retrofit kit may further comprise a further edge profile opposite the edge profile, the further edge profile comprising a plurality of apertures for receiving mounting screws for securing the further panel profile to the troffer. Such an LED panel may simply be swiveled or hinged from its hanging position into its final position around the mounting hooks of the mounting brackets and secured into its final position using screws through said apertures.

The LED panel retrofit kit may further comprise a diffuser sheet for mounting over a light emission surface of the LED panel, said light emission surface carrying a plurality of LEDs and extending between the edge profile and the further edge profile. Such a diffuser sheet may diffuse the luminous output produced by the LEDs and may reduce glare produced by a troffer fitted with the LED panel retrofit kit if such a troffer does not comprise a diffuse light exit window, e.g. a diffuse translucent cover plate.

According to yet another aspect, there is provided a method of fitting the LED panel retrofit kit of any of the embodiments described in this application into a troffer, the method comprising fitting the mounting brackets of said mounting bracket arrangement at opposing end surfaces of the troffer; hanging the LED panel from said mounting brackets by engaging the mounting hooks with the edge profile of the LED panel; connecting the LED panel to a power supply; swiveling the LED panel around the mounting hooks such that the further edge profile of the LED panel contacts the roof section of the troffer; and screwing the LED panel to said roof section through the apertures in the further edge profile of the LED panel. Accordingly, an LED panel may be retrofitted into an existing troffer in a particularly straightforward manner.

Fitting the mounting brackets of said mounting bracket arrangement at opposing end surfaces of the troffer may comprise aligning the respective alignment edges of the mounting brackets of said mounting bracket arrangement with an alignment feature of the troffer; adhering the aligned mounting brackets to the roof section of the troffer; and screwing the aligned mounting brackets to the roof section through one of the at least one aperture of each bracket. By first adhering the aligned mounting brackets to the roof section, the mounting brackets may be more easily permanently affixed in their correct location as the risk of the mounting brackets slipping from their intended position during screwing the mounting brackets into place is significantly reduced. This therefore improves ease of installation.

### BRIEF DESCRIPTION OF THE DRAWINGS

Embodiments of the invention are described in more detail and by way of non-limiting examples with reference to the accompanying drawings, wherein:

FIG. 1 schematically depicts a LED panel retrofit kit according to an example embodiment;

FIG. 2A schematically depicts a perspective view of a bracket arrangement according to an example embodiment;

FIG. 2B schematically shows some embodiments of a mounting hook;

FIG. 3 schematically depicts a perspective view of a mounting bracket of such a bracket arrangement in its intended position in a troffer;

FIG. 4 schematically depicts a perspective view of an LED panel hanging from the bracket arrangement fitted to a troffer; and

FIG. 5 is an image of an LED panel in its final position within a troffer after swiveling the LED panel into place.

### DETAILED DESCRIPTION OF THE EMBODIMENTS

It should be understood that the Figures are merely schematic and are not drawn to scale. It should also be understood that the same reference numerals are used throughout the Figures to indicate the same or similar parts.

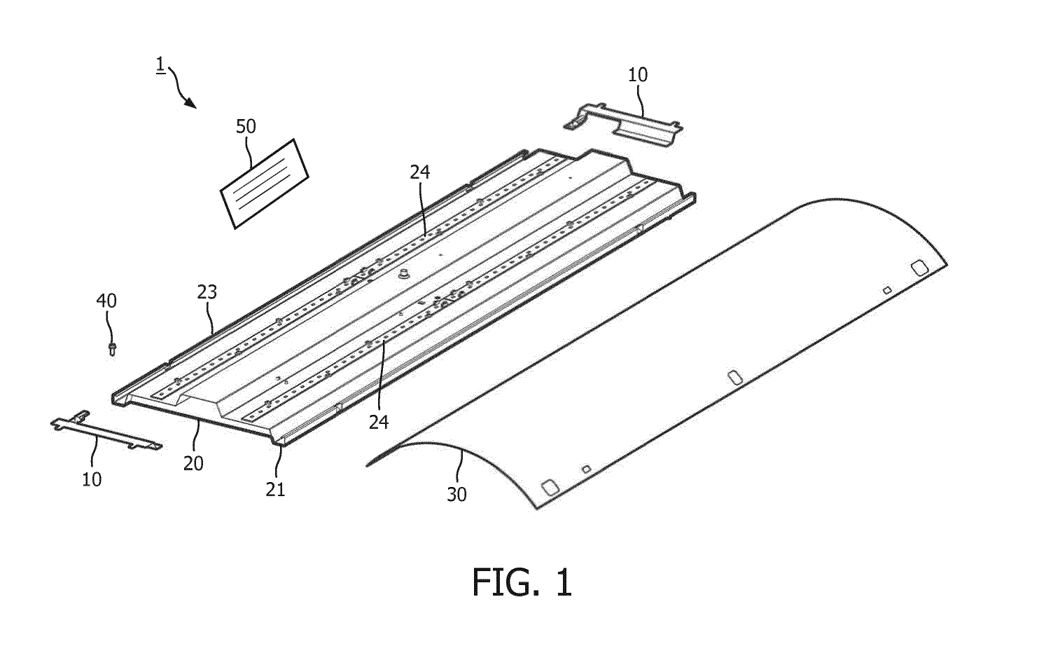

FIG. 1 schematically depicts an example embodiment of an LED panel retrofit kit 1. The LED panel retrofit kit 1 typically comprises a mounting bracket arrangement including a pair of mounting brackets 10 for mounting an LED panel 20 into a troffer as will be explained in more detail below. The LED panel 20 comprises a first edge profile 21, which is adapted to engage with the mounting brackets 10 as will be explained in more detail below. The LED panel 20 further comprises a further edge profile 23 opposite the first edge profile 21, which further edge profile facilitates the LED panel 20 to be permanently affixed to a troffer, e.g. by screwing. The first edge profile 21 and the further edge profile 23 may be arranged along opposing major edges of the LED panel 20. The LED panel 20 further comprises one or more arrays 24 of LEDs running in parallel with these major edges, e.g. one or more strips or boards of LEDs, which may be affixed to the LED panel 20 in any suitable manner, e.g. through adhesion, screwing or the like. The LED panel may have any suitable dimensions, e.g. may be dimensioned to fit standard troffer sizes, e.g. a 60 cm×60 cm (2′×2′) troffer, a 60 cm×120 cm (2′×4′) troffer or a 120 cm×120 cm (4′×4′) troffer although other sizes are of course equally feasible.

The LED panel retrofit kit 1 may further comprise an arcuate diffuser sheet 30 to be fitted over the LED panel 20 such that the one or more arrays 24 of LEDs are obscured by the diffuser sheet 30, i.e. the respective luminous outputs produced by the LEDs are directed at the arcuate diffuser sheet 30 when fitted over the LED panel 20. The LED panel retrofit kit 1 may further comprise mounting screws 40 for affixing the mounting brackets 10 and the further edge profile 23 to a troffer to be retrofitted with the LED panel, and may further comprise a troffer label 50, which label may be used for identification purposes and/or may contain installation, maintenance and/or specification details of the LED panel 20.

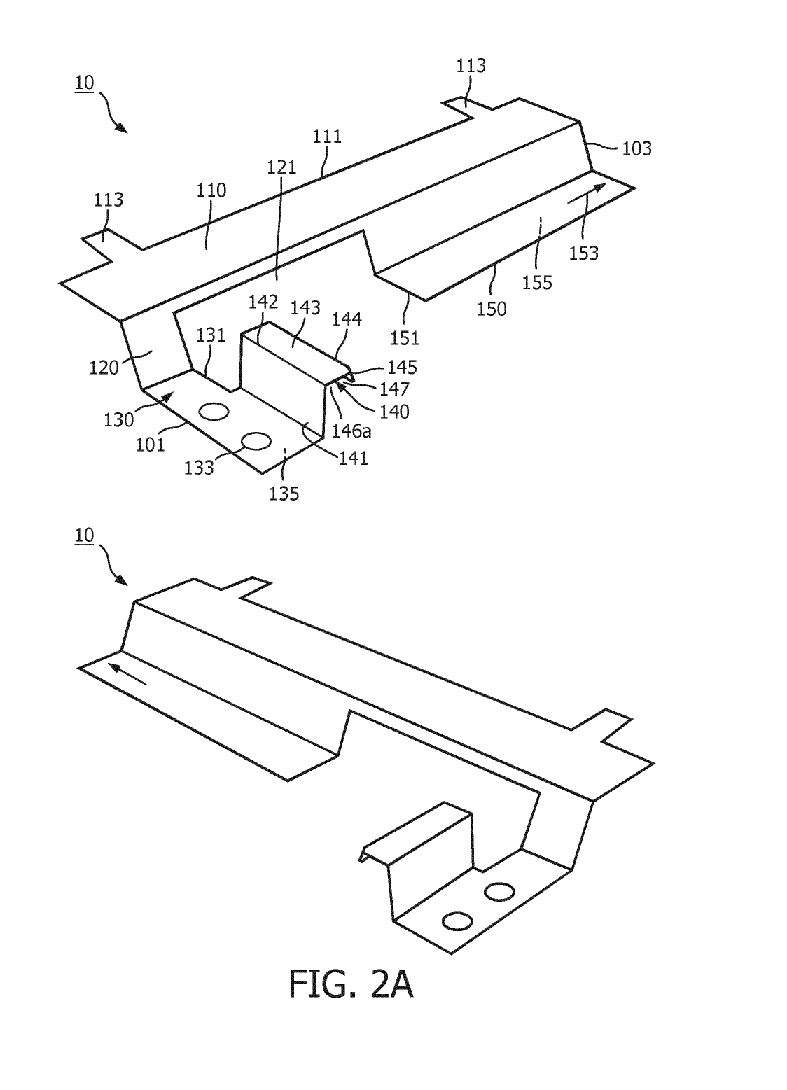

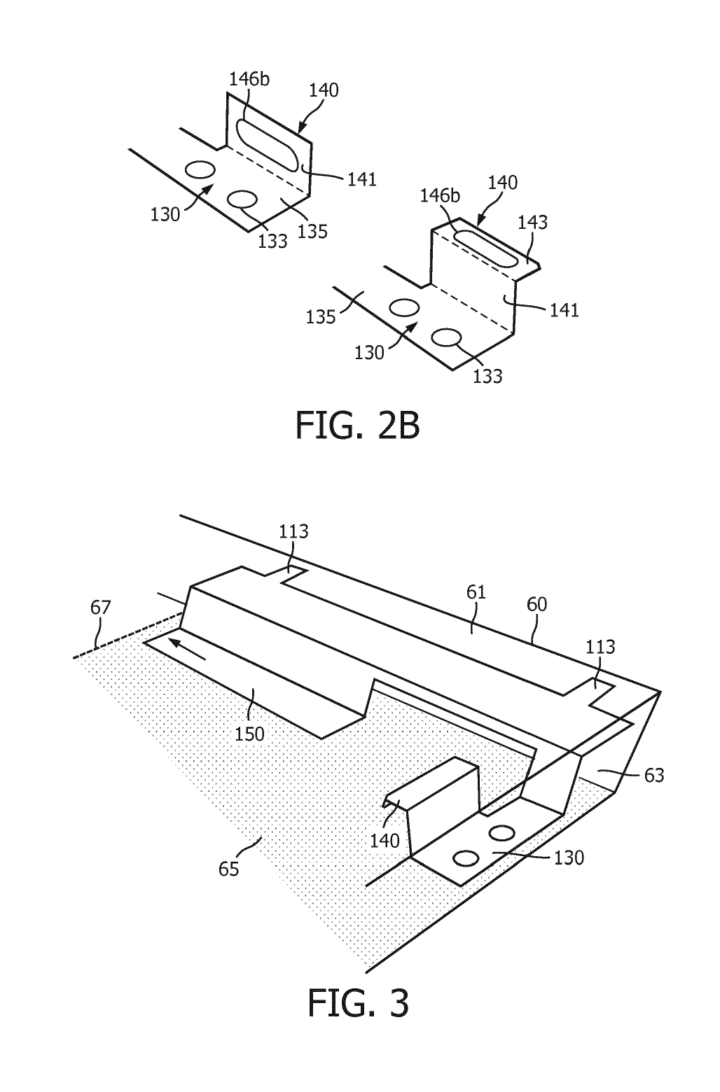

FIG. 2A schematically depicts a mounting bracket arrangement for the LED panel retrofit kit 1. The mounting bracket arrangement includes a pair of mounting brackets 10, which may be mirror images of each other although this is not strictly necessary. FIG. 3 schematically depicts a desired positioning of such a mounting bracket 10 in a troffer 60. FIGS. 2A and 3 together will now be described in more detail. The mounting bracket 10 typically comprises a major edge 111 for positioning the major edge 111 against an end surface 61 of the troffer 60. The end surface 61 may be a sidewall of the troffer 60 and is typically the sidewall from which the LED panel 20 is to extend. In other words, the respective major edges 111 of the mounting brackets 10 are to be positioned against opposing end surfaces 61, with the LED panel 20 extending between these opposing end surfaces 61, i.e. along a further sidewall 63 extending between the opposing sidewalls having the opposing end surfaces 61.

Preferably, the major edge 111 may include a pair of protrusions 113 (additional protrusions 113 may be present) for positioning the major edge 111 against the appropriate end surface 61 of the troffer 60. The presence of such protrusions 113 for example may be beneficial where the end surface 61 is not flush, e.g. contains legacy fittings of the lamps removed from the troffer 60, such that the removal of such legacy fittings is not required to correctly position the major edge 111 against the end surface 61, as such legacy fittings may be positioned in between the protrusions 113. The protrusions 113 alternatively or additionally may be used as reference features for correctly positioning the mounting bracket 10 within the troffer 60.

Each mounting bracket 10 further comprises an alignment edge 103 extending transversely from the major edge 101. In some embodiments, the alignment edge 103 extending transversely from the major edge 101 under an angle ranging from about 80° to about 100°. The alignment edge 103 may extend perpendicularly from the major edge 101. The alignment edge 103 is typically located at a side of the mounting bracket arranged to face a central area of the troffer 60. The alignment edge 103 for example may have the purpose of aligning the mounting bracket 10 with a particular feature of the troffer 60, such as a central line 67 of the troffer 60 extending between the opposing end surfaces 61. Such a central line 67 may be visibly marked or may be a virtual central line. The alignment edge 103 may delimit an alignment portion 150 of the mounting bracket 10, which alignment portion 150 may carry a visible marker 153, e.g. an arrow or the like possibly combined with an identification of the intended troffer feature with which the alignment edge of 103 is to be aligned, to aid an installer of the LED panel retrofit kit 1 to correctly align the mounting brackets 10 within the troffer 60.

Each mounting bracket 10 further comprises an affixing portion 130 having a contact surface 135 for contacting a roof section 65 of the troffer 60. The roof section 65 may be an upper panel of the troffer 60, i.e. a panel arranged opposite the light exit window of the troffer 60. The affixing portion 130 comprises at least one aperture 133 and preferably comprises at least a pair of apertures 133 spatially separated from each other for receiving the screw thread of a screw 40 for screwing the mounting bracket 10 to the roof section 65. The provision of multiple apertures 133 has the advantage of increased installation tolerance, for example to negate the potential risk of a single aperture 133 being difficult to access because of an obstructing legacy fixture in the troffer 60.

Each mounting bracket 10 further comprises a mounting hook 140 extending from the affixing portion 130 in a direction away from the roof section 65 of the troffer 60. As will be explained in more detail below, the mounting hooks 140 are shaped such that the LED panel 20 can be hung from the mounting hooks 140 in an ‘open’ position in which the LED panel 20 hangs more or less perpendicularly relative to the roof section 65, thereby allowing the installer to connect a power supply to the LED panel 20 without having to support or retain the LED panel 20 in the process. Upon completion of such electrical installation, the mounting hooks 140 further allow the LED panel 20 to be swiveled around the mounting hooks 140 into a ‘closed’ position in which the LED panel 20 aligns with the roof section 65 such that the further edge profile 23 of the LED panel 20 contacts the roof section 65, thereby allowing the installer to secure the further edge profile against the roof section 65, e.g. by screwing the further edge profile against the roof section 65.

Each mounting hook 140 may have a first section 141 extending from the affixing portion 130 in a direction away from the roof section 65 of the troffer 60, a second section 143 extending from an edge 142 of the first section 141 parallel to the contact surface 135, and a third section 145 extending from an edge 144 of the second section 143 towards the contact surface 135. The first, second and third section enclosing an elongated groove 146a with the opening 147 of the facing the contact surface 135. The angle between the affixing portion 130 and the first section 141 may be larger than 90°, i.e. the first section 141 may be slanted relative to the affixing portion 130 and the angle between the third section 145 and the second section 143 may be larger than 90°, i.e. the first section 141 may be slanted relative to the second section 143 in order to facilitate the swiveling or hinging of the LED panel 20 around the mounting hook 140. However, it should be understood that the mounting hooks 140 may have any suitable shape, e.g. any U-shape like shape. Some embodiments of mounting hooks 140 are shown in FIG. 2B. In these embodiments the hook 140 comprises an elongated slot 146b extending alongside the alignment edge.

In an embodiment, each affixing portion 130 may be delimited by a first edge 101 defining the edge of the mounting bracket 10 facing the further side wall 63 of the troffer 60 and a first further edge 131. Each mounting hook 140, e.g. the first section 141, may extend from the first further edge 131 such that the one or more apertures 133 are not obscured by the mounting hook 140, i.e. the mounting hook 140 does not overhang the one or more apertures 133, which facilitates easy access to the one or more apertures 133. It should however be understood that the mounting hook 140 may extend from the affixing portion in any suitable manner, e.g. the first section may extend from the first edge 101 instead. Moreover, the second section 143 may extend from the edge 142 away from the affixing portion 130, as shown, or towards the affixing portion 130 (not shown).

In an embodiment, each mounting bracket 10 has a stepped profile in which a first step portion 110 of the mounting bracket 10 is delimited by the major edge 111 and in which the affixing portion 130 and the alignment portion 150 define a second step portion of the stepped profile, with an adjoining portion 120 extending between the first step portion 101 and the second step portion including the affixing portion 130 and the alignment portion 150.

The adjoining portion 120 may be slanted relative to the first step portion 101 and the second step portion, i.e. extend non-perpendicularly between the first step portion 101 and the second step portion such that the second step portion is further away from the end surface 61 than the first step portion 110. This for example allows legacy fixtures of the troffer 60 on the end surface 61 to be hidden behind the mounting bracket 10 without requiring removal of these legacy fixtures. In this embodiment, the alignment edge 103 may delimit the first step portion 110, the adjoining portion 120 and the alignment portion 150, whereas the first edge 101 may delimit the first step portion 110, the adjoining portion 120 and the affixing portion 130.

Each mounting bracket 10 may further comprise a recess 121 in between the first further edge 131 of the affixing portion 130 and a second further edge 151 of the alignment portion 150 facing the first further edge 31 of the affixing portion 130 and being spatially separated therefrom by the recess 121. The recess 121 typically at least partially extends into the adjoining portion 120. Such a recess 121 may further assist in accommodating legacy fixtures in the troffer 60 by allowing the mounting bracket 10 to be positioned around such legacy fixtures without requiring their removal.

In an embodiment, at least one of the respective contact surfaces 135, 155 of the affixing portion 130 and the alignment portion 150 of each mounting bracket 10 comprises an adhesive area, e.g. a portion of double-sided tape for at least temporarily adhering the mounting bracket 10 to the roof section 65 of the troffer 60. In this manner, the installer of the LED panel retrofit kit 1 may adhere a correctly positioned mounting bracket 10 to the roof section 65, e.g. by pressing the correctly positioned mounting bracket 10 against the roof section 65 to make the mounting bracket 10 ‘stick’, after which the installer can affix the correctly positioned mounting bracket 10 by screwing as previously explained without having to worry that the mounting bracket 10 strips from its correct position, which may prevent the correct positioning of the LED panel 10 within the troffer 60.

The mounting brackets 10 may be made of any suitable material, e.g. a metal or metal alloy. For example, the mounting brackets 10 may be made of aluminium. The mounting brackets 10 may be coated with a corrosion-resistant coating to enhance the lifetime of the mounting brackets 10; for example, the mounting brackets 10 may be painted, electroplated, powder coated and so on to protect the mounting brackets 10 from corrosion.

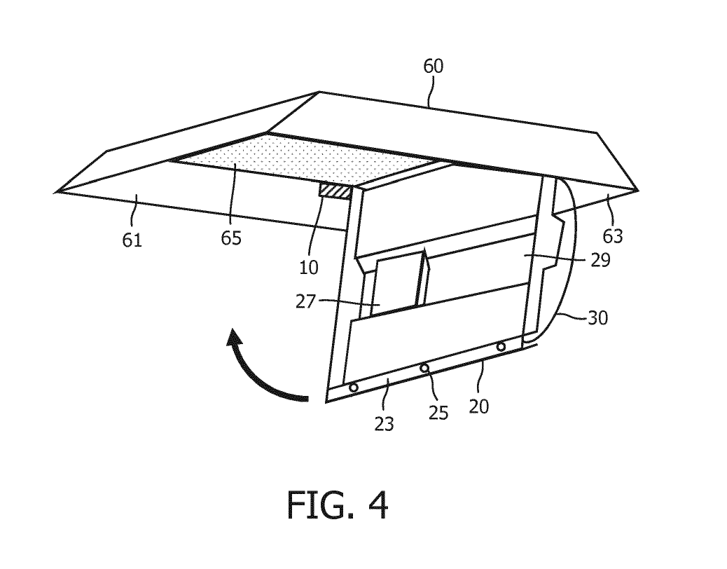

FIG. 4 schematically depicts a LED panel 20 fitted to the mounting brackets 10 positioned on opposing end surfaces 61 of a troffer 60. Each mounting bracket 10 is affixed to the roof section 65 of the troffer 60 as previously explained. The LED panel 20 hangs from the mounting hooks 140 in an ‘open’ position, i.e. an orientation facilitating easy access to one or more components 27 at the back of the LED panel 20 to be connected to a power supply, e.g. a ballast, a driver circuit, or the like. The LED panel 20 may comprise a trench 29 in which the one or more components 27 are positioned to facilitate a flush arrangement between the LED panel 20 and the roof section 65 of the troffer 60 when the LED panel 20 is in its closed position.

The LED panel 20 is typically hung from the mounting hooks 140 such that the light emitting surface of the LED panel 20, i.e. the surface carrying the one or more arrays 24 of LEDs is facing the sidewall 63 of the troffer 60 proximal to the LED panel 20. The LED panel 20 may be hung from the mounting hooks 140 in any suitable manner. For example, the first edge profile 21 of the LED panel 20 may be shaped such that it can engage with the mounting hooks 140. Alternatively, the first edge profile 21 may comprise a pair of apertures or recesses (not shown), e.g. slits, dimensioned such that the mounting hooks 140 can extend through these apertures or recesses.

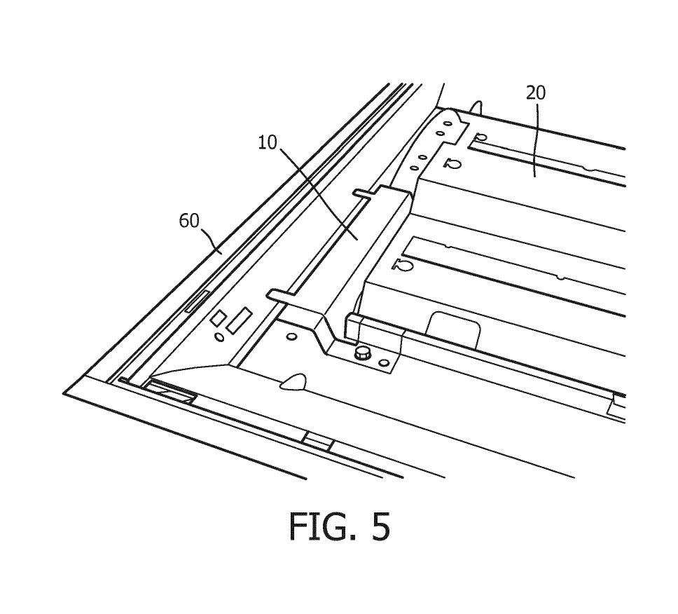

As previously explained, the mounting hooks 140 act as hinges for the LED panel 20, such that the LED panel 20 may be swiveled into its final, i.e. closed, position when the electrical installation of the LED panel 20 within the troffer 60 has been completed, as indicated by the arrow in FIG. 4. This hinging or swiveling action may bring the further edge profile 23 of the LED panel 20 into contact with the roof section 65 of the troffer 60, such that the installer of the LED panel retrofit kit 1 can secure the LED panel 20 against the roof section 65 by screwing one or more screws 40 through the apertures 25 in the further edge profile 23. FIG. 5 is an image of the LED panel 20 held into place in its final position within the troffer 60 by the mounting brackets 10.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A mounting bracket arrangement for retrofitting an LED panel in between opposing end surfaces of troffer, the mounting bracket arrangement comprising a pair of mounting brackets, each mounting bracket comprising:
a major edge for abutting the mounting bracket against one of said end surfaces;
an alignment edge extending transversely from the major edge;
an affixing portion having a contact surface for contacting a roof section of the troffer; and
a mounting hook extending from the affixing portion for hanging the LED panel from the mounting bracket, said mounting hook having an elongated slot or groove with an opening, and said slot or groove extends in a direction alongside the alignment edge,
wherein each mounting bracket has a stepped profile comprising a first step portion, the affixing portion as a second step portion and an adjoining portion extending from the first step portion to the second step portion,
wherein the mounting bracket arrangement-further comprises a first edge shared by the first step portion, the adjoining portion and the second step portion; wherein the second step portion comprises a first further edge opposing the first edge, the mounting hook extending from the first further edge in the direction of the first step portion,
each mounting bracket further comprising
an alignment portion extending from the adjoining portion, wherein the alignment edge is shared by the first step portion, the adjoining portion and the alignment portion; wherein the alignment portion comprises a second further edge opposing the alignment edge, the first further edge and the second further edge facing each other and being spatially separated.

2. The mounting bracket arrangement of claim 1, wherein the mounting brackets are mirror images of each other.

3. The mounting bracket arrangement of claim 1, wherein each mounting hook has a first section extending from the affixing portion, a second section extending from an edge of the first section parallel to the contact surface of the affixing portion and a third section extending from an edge of the second section towards said contact surface, the first, second and third section enclosing the elongated slot or groove with the opening of the slot or groove facing the contact surface.

4. (canceled)

5. (canceled)

6. (canceled)

7. The mounting bracket arrangement of claim 1, wherein the alignment portion further comprises a visual marker for aligning the alignment edge with a reference location in the troffer.

8. The mounting bracket arrangement of claim 7, wherein the major edge of each mounting bracket comprises a pair of protrusions near opposite ends of the major edge for positioning the major edge against the end surface of the troffer.

9. The mounting bracket arrangement of claim 8, wherein the affixing portion of each mounting bracket comprises at least one aperture for allowing a screw thread to pass through the aperture.

10. The mounting bracket arrangement of claim 9, wherein each mounting bracket comprises an adhesive area for at least temporarily adhering the mounting bracket to the roof section of the troffer of the mounting bracket for contacting the roof section of the troffer.

11. An LED panel retrofit kit for a troffer, the kit comprising the mounting bracket arrangement of claim 10 and an LED panel comprising an edge profile for engaging with the respective hook members of the mounting brackets.

12. The LED panel retrofit kit of claim 11, further comprising a further edge profile opposite the edge profile, the further edge profile comprising a plurality of apertures for receiving mounting screws for securing the further panel profile to the troffer.

13. The LED panel retrofit kit of claim 11, further comprising a diffuser sheet for mounting over a light emission surface of the LED panel, said light emission surface carrying a plurality of LEDs and extending between the edge profile and the further edge profile.

14. A method of fitting the LED panel retrofit kit of claim 11 into a troffer, the method comprising:
fitting the mounting brackets of said mounting bracket arrangement at opposing end surfaces of the troffer;
hanging the LED panel from said mounting brackets by engaging the mounting hooks with the edge profile of the LED panel;
connecting the LED panel to a power supply;
swiveling the LED panel around the mounting hooks such that the further edge profile of the LED panel contacts the roof section of the troffer; and
screwing the LED panel to said roof section through the apertures in the further edge profile.

15. The method of claim 14, wherein fitting the mounting brackets of said mounting bracket arrangement at opposing end surfaces of the troffer comprises:
aligning the respective alignment edges of the mounting brackets of said mounting bracket arrangement with an alignment feature of the troffer;
adhering the aligned mounting brackets to the roof section of the troffer; and
screwing the aligned mounting brackets to the roof section through one of the at least one aperture of each mounting bracket.
